(19) United States
(12) Patent Application Publication
(10) Pub. No.: US 2014/0232920 A1
(43) Pub. Date: Aug. 21, 2014

(54) PHOTOGRAPHY GUIDE METHOD, DEVICE AND STORAGE MEDIUM USING SUBJECT CHARACTERISTIC

(71) Applicant: Samsung Electronics Co., Ltd., Gyeonggi-do (KR)

(72) Inventor: Moon-Soo KIM, Seoul (KR)

(73) Assignee: Samsung Electronics Co., Ltd., Gyeonggi-do (KR)

(21) Appl. No.: 14/017,658

(22) Filed: Sep. 4, 2013

(30) Foreign Application Priority Data
Feb. 21, 2013 (KR) 10-2013-0018762

(51) Int. Cl. H04N 5/232

(52) U.S. Cl. CPC H04N 5/23293
USPC 348/333.02

(57) ABSTRACT

A photography guide method, a photography guide device, and a photography guide storage medium that use a subject's characteristics when capturing an image. The photography guide method that uses a subject's characteristics includes: detecting at least one subject in an image for prospective recording obtained from an image sensor; determining a distance between the image sensor and the subject; setting a disposing region of the detected subject on a screen where the image for prospective recording is displayed according to the determined distance; and guiding the detected subject in such a manner that the position of the detected subject is positioned in the set disposing region.

### CLAIM OF PRIORITY

This application claims the benefit of priority under 35 U.S.C. §119(a) from Korean Application Serial No. 10-2013-0018762, which was filed in the Korean Intellectual Property Office on Feb. 21, 2013, the entire content of which is hereby incorporated by reference in its entirety.

### BACKGROUND

1. Field of the Invention

The present disclosure generally relates to an electronic device provided with a camera device or a camera function. More particularly, the present invention relates to a photography guide method, a photography guide device, and a photography guide storage medium that provides a photography guide based on predetermined aspects when a user photographs a subject with an electronic device provided with a photographing device or a photographing function.

2. Description of the Related Art

In general, in a method of photographing a subject using a photographic device such as a camera, or an electronic device with various functionalities unrelated to capturing an image and may also include a camera module for photographing, such methods acquire image data from an image sensor of the photographing device that is displayed on a display as a preview, and the acquired image data is stored in a memory when a user renders a command to control photographing.

In a photographic device, various technologies, such as autofocus, self-photographing and hand-shaking prevention technologies, are applied in order to allow the user to easily operate the photographic device. In addition, a camera function is also provided in various electronic devices including a portable terminal, such as a portable phone, a smart phone, a camera, a tablet PC, a wearable computing device e.g., head-mounted device. Consequently, it has become possible to conveniently photograph still images or moving images at any time, and in any place.

Recently, photography guide technologies have been developed that assist ordinary persons who are not experts in photography to facilitate operation of a photographic device when taking pictures using the photographic device, so that the ordinary person can take good quality pictures.

Among the photography guide technologies developed up to now, there are technologies that consider a photographic composition, in which image data acquired by an image sensor of a photographing device is generally transmitted to an image processor, such as the face of a person detected by the image processor, the size and proportion of the face of the person are determined, the distance to the person is estimated, and then a guide is made as to how to dispose the person in the image for a good composition. Japanese Patent Laid-Open Publication No. 2005-269562 entitled “Photographing Apparatus,” invented by Ayaki Kenichiro, filed in the name of Fuji Photo Film Co. Ltd., and published on Sep. 29, 2005 discloses a technology in which the position of the face of a person is detected from an image obtained by an imaging means, and a guide is made so that the detected position of the person's face may be disposed in a predetermined position in the image.

In the above-described Japanese Laid-Open Publication, a problem can occur in that, since the distance to a person is estimated by detecting the face of the person, the technology of guiding the photographing is not applicable when photographing a subject other than a person.

### SUMMARY

Various aspects of the present invention provide a photography guide method both subjects which are persons, but also for various other subjects in an image obtained through an image sensor in an electronic device (for example, a camera device or a user device with a camera function, such as a portable electronic device, tablet, mobile communication terminal, etc.).

According to an exemplary aspect of the present invention, a photography guide method is provided that makes use of subject's characteristics. The photography guide method can include: detecting at least one subject in a to-be-photographed image (i.e. an image for prospective recording) obtained from an image sensor; determining a distance between the image sensor and the subject; setting a disposing region of the detected subject on a screen where the image for prospective recording is displayed according to the determined distance; and guiding the detected subject such that the position of the detected subject is positioned in the set disposing region.

According to another exemplary aspect of the present invention, a photography guide device is provided that makes use of a subject's characteristics. The photographing device can include: an image sensor configured to obtain a to-be-photographed image (i.e. an image for prospective recording); a detection unit configured to detect at least one subject from the image for prospective recording obtained through the image sensor; a measuring unit configured to determine a distance between the image sensor and the subject; a setting unit configured to set a disposing region of the detected subject on a screen where the image for prospective recording is displayed according to the determined distance; and a controller configured to control an operation of guiding the detected subject such that the position of the detected subject is positioned in the set disposing region. The characteristics are not merely limited to face detection as in conventional devices.

According to still another exemplary aspect of the present invention, a non-transitory machine-readable storage medium is provided that stores a program that when loaded into hardware such as a processor, microprocessor, or control executes a photography guide method which uses a subject's characteristics. Execution of the program may include: detecting at least one subject in an image for prospective recording obtained from an image sensor; determining a distance between the image sensor and the subject; setting a disposing region of the detected subject on a screen where the image for prospective recording is displayed according to the determined distance; and guiding the detected subject in such a manner that the position of the detected subject is positioned in the set disposing region. Determining the distance between the image sensor and the subject may include: determining the moving distance of the lens moved as an autofocus (AF) function of the image sensor is executed, and determining the distance between the image sensor and the subject at least based on the moving distance of the lens.

According to the photography guide method, the photography guide device, and the storage medium, it is possible to provide a photography guide for not only a subject which is a person, but also for various other subjects in an image obtained from an image sensor using an electronic device (for example, a camera device or a user device with a camera function, such as a portable phone or a tablet computer) so that a user can take photographs which are good in an aspect of composition. In addition, an advantage of the present includes that since a disposing region of a subject in a photograph may be guided based on a distance between the electronic device (for example, the image sensor of the electronic device) and the subject, the user's convenience can be enhanced.

### BRIEF DESCRIPTION OF THE DRAWINGS

The above and other exemplary aspects, features, and advantages of the present invention will be better appreciated by a person of ordinary skill in the art from the following detailed description taken in conjunction with the accompanying drawings, in which:

FIG. 1 is a block diagram illustrating a portable terminal that performs a photography guide operation using a subject characteristic according to an exemplary embodiment of the present invention;

FIG. 2 is a flowchart illustrating exemplary operation of a photography guide operation using a subject character according to another exemplary embodiment of the present invention;

FIGS. 3A and 3B are exemplary views illustrating moving distance measuring operations of a lens moved by performing an autofocus operation according to the exemplary embodiment of FIG. 2;

FIGS. 4A and 4B are exemplary views illustrating the results of making a guide to move a subject to a predetermined position in an image of a display unit in advance according to the exemplary embodiment of FIG. 2;

FIG. 5 is an exemplary view illustrating a photography guide operation using a subject character according to another exemplary embodiment of the present invention;

FIG. 6 is an exemplary view illustrating a photography guide operation using a subject characteristic according to yet another exemplary embodiment of the present invention; and

FIG. 7 is an exemplary view illustrating a photography guide operation using a subject characteristic according to still another exemplary embodiment of the present invention.

### DETAILED DESCRIPTION

Hereinafter, various exemplary embodiments of the present invention will be described with reference to the accompanying drawings. In the following description, various specific features, such as names and constituting elements, for example, disposing region, detection unit, measuring unit, and setting unit, found in the following description are provided only to help general understanding of the present invention, and it is apparent to those skilled in the art that a modification or change may be made to those features within the spirit and scope of the presently claimed invention. An artisan should understand and appreciate that each of the elements described herein may mean either a singular component or plural components unless it is defined otherwise.

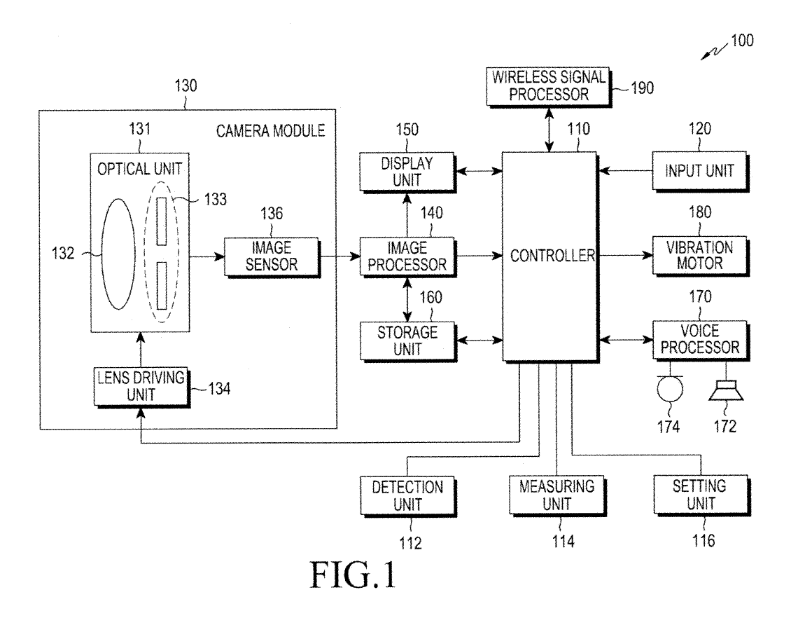

FIG. 1 is a block diagram illustrating a portable terminal that performs a photography guide operation using a subject characteristic according to an exemplary embodiment of the present invention. All of the units are hardware and comprise statutory subject matter, having at least one of circuitry, a processor or microprocessor chip, etc. Referring now to FIG. 1, a portable terminal 100 in this example can include a controller 110, a detection unit 112, a measuring unit 114, a setting unit 116, an input unit 120, a camera module 130, an image processor 140, a display unit 150, a storage unit 160, a voice processor 170, a speaker 172, a microphone 174, a vibration motor 180, and a wireless signal processor 190. The camera module 130 includes hardware such as an optical unit 131, a lens driving unit 134, and an image sensor 136, and the optical unit 131 may include a lens 132 and a shutter 133.

The input unit 120 includes at least one button or a keypad so as to receive the input of user commands to perform a setting and operation of each of the functions of the portable terminal 100. Here, the button of the input unit 120 may be formed on the front surface, a side surface, or the rear surface of the portable terminal 100, or may be a virtual form displayed on a touch screen. In addition, the keypad of the input unit 120 may include a physical key pad formed on the portable terminal 100 or a virtual keypad displayed on the touch screen. However, the physical keypad formed on the portable terminal 100 may be omitted depending on the performance or configuration of the portable terminal 100.

The camera module 130 includes hardware such an optical unit 131, a lens driving unit 134, and an image sensor 136, which may perform an ordinary digital camera function, such as photographing still images and moving images, and may also perform a function of acquiring an image through the image sensor 136 when the camera module 130 is operated.

The optical unit 131 can include a lens 132 and a shutter 133, and can be driven by the lens driving unit 134 to capture a surrounding image, and can perform zooming and focusing operations or the like as the lens 132 of the optical unit 131 is driven by the lens driving unit 134.

The image sensor 136 senses and converts an image captured by the optical unit 131 into an electrical signal. The image sensor 136 comprises hardware such as a Complementary Metal-Oxide-Semiconductor (CMOS) or a Charge Coupled Device (CCD) sensor, or a sensor capable of sensing an image of a Ultra High Definition (UHD) or an even higher level. The image sensor 136 of the camera module 130 can be provided with a global shutter therein. The global shutter performs a function similar to that of an ordinary mechanical shutter. Also, the image sensor 136 may include not only the image sensor 136 provided in the camera module 130 of the portable terminal 100, but also an image sensor 136 wirelessly connected through a wireless signal processor 190, for example, a Wi-Fi direct or NFC (Near Field Communication) device.

In addition, the camera module 130 can be provided with a view finder.

The image processor 140, which is configured with machine executable code, performs an image processing operation for images captured by the camera module 130 or images provided from an external apparatus. In other words, the image processor 140 can input to-be-photographed images (sensed but not yet captured images) acquired from the camera module 130 in lines or frames, and may process a unit image to produce a display image and a compressed and encoded image. For example, the image processor 140 may convert a sensed but not yet photographed (to-be-photographed image) sensed by the image sensor 136 of the camera module 130 into a digital image and output the digital image. At this time, the output data can comprise a Bayer data (raw data).

The display unit 150 includes a display device such as an LCD or an LED, OLED, and can be implemented in a touch screen configuration, and may display various images for executing various application programs of the portable terminal 100, operating states, menu states, etc.

In addition, according to an exemplary aspect of the present invention, the display unit 150 may display a image for prospective recording acquired through the lens 132 of the camera module 130, or may display photo images or moving images previously photographed by the camera module 130 and stored in the storage unit 160. In addition, the display unit 150 can display a disposing region determined by performing the inventive photography guide operation of the present invention. The disposing region at this time (prior to actually photographing the image) is a region recommended as the position of a subject in the image for prospective recording so that successful photographing may be performed by taking into account the determined distance between the subject and the image sensor 136 in the camera module 130 and the photographic composition at the time of photographing.

The storage unit 160 can store various contents, various application programs and data related to the contents and processing of the operations in addition to photographed photo images. In accordance with an operation according to the present invention, the storage unit can store, for example, an image for prospective recording or photographed images in the camera module 130.

The voice processor 170 can convert an electrical voice signal according to the control of the controller 110 to an audio signal output as a voice or sound through the speaker 172, and may convert a voice or sound input through the microphone 174 into an electrical signal.

The speaker 172 outputs various signals of the camera module 130, for example, sound signals corresponding to a digital moving image file, a photographing operation, or the like, to the outside of the portable terminal 100 according to the control of the controller 110. The speaker 172 can output a sound corresponding to a function executed by the portable terminal 100. According to an exemplary aspect of the present invention, the speaker 172 can perform an operation of outputting a preset voice or signal sound that guides the subject to be positioned at the disposing region determined by performing the photography guide operation.

The microphone 174 can receive an input of the user's voice.

The vibration motor 180 can convert an electrical signal into mechanical vibration according to the control of the controller 110, in which one or more vibration motors may be formed in the housing of the portable terminal 100. The vibration motor can be operated in response to the user's touch action on the touch screen and a continuous movement of the touch on the touch screen. Also, according to an exemplary aspect of the present invention, the vibration motor 180 is operated when the subject is positioned in the disposing region determined by performing the photography guide operation of the present invention so that the user can feel the vibration thereof when the user grips the portable terminal 100.

The wireless signal processor 190 performs a wireless signal processing operation for a wireless communication function, in which the wireless signal processor 190 can include, for example, an antenna, an RF unit comprising hardware such as transceiving circuitry, and a MODEM. The RF unit can include, a transceiver or a separate RF transmitter configured to up-convert the frequency of a transmitted signal and amplify the transmitted signal, and an RF receiver configured to low-noise amplify a received signal and down-convert the received signal. The MODEM can include, for example, a transmitter having circuitry configured to encode and modulate a signal to be transmitted, and a receiver having circuitry configured to decode and demodulate a signal received from the RF unit. In addition, the wireless signal processor 190 can be provided with a short-range wireless communication module, for example, a wireless LAN module, a Wi-Fi direct device, an NFC (Near Field Communication) device, or a Bluetooth, so that the wireless signal processor 190 may be connected wirelessly to the Internet or the like in a place where a wireless access point (AP) is provided or may conduct wirelessly a short-range communication operation with peripheral devices.

The detection unit 112 can detect at least one subject from an image for prospective recording obtained through the image sensor 136. For example, when the AF (Autofocus) function of the image sensor 136 is executed, the detection unit 112 contains circuitry configured to determine a focused object as a subject.

The measuring unit 114 can determine the distance between the image sensor 136 and the subject. For example, the measuring unit 114 contains circuitry configured to measure the moving distance of the lens 132 moved as the autofocus function of the image sensor 136 is executed, and determines the distance between the image sensor 136 and the subject based on the measured moving distance of the lens 132. Alternatively, the measuring unit 114 can measure the time required for the light emitted as the flash function of the portable terminal 100 to be reflected from the subject and returned to the image sensor 136, and determine the distance between the imager sensor 136 and the subject based on the measured time required for the emitted light to be reflected from the subject and returned to the image sensor 136.

The setting unit 116 contains circuitry configured to set a disposing region of the detected subject on a screen where an image for prospective recording is displayed based on the distance between the image sensor 136 and the subject determined through the measuring unit 114. In other words, the setting unit 116 can change a preset subject disposing standard region, which is previously stored according to a photographic composition, according to the distance between the image sensor 136 and the subject determined through the measuring unit 114 to set a disposing region of the subject.

The controller 110 includes circuitry such as, for example, a ROM configured to store a control program for controlling the portable terminal 100, and a RAM configured to store a signal or data input from the outside of the portable terminal 100 or to be used as a memory region for an operation executed in the portable terminal 100. In addition, the controller can include CPU (which can be in the form of circuitry such a processor or microprocessor and can include a single core, a dual core, a triple core, or a quad core structure. Furthermore, the CPU, the RAM and the ROM may be connected with each other through internal buses.

The controller 110 can control operations of the detection unit 112, the measuring unit 114, the setting unit 116, the input unit 120, the camera module 130, the image processor 140, the display unit 150, the storage unit 160, the voice processor 170, the speaker 172, the microphone 174, the vibration motor 180, and the wireless signal processor 190.

In addition, the controller 110 can control the operation of guiding the position of the subject detected by the detection unit 151 to be positioned in the disposing region set by the setting unit 155.

Of course, the portable terminal 100 can be additionally provided with functional units, such as a power source unit including circuitry configured by a chargeable battery or the like and a sensor module, that are applied to a conventional portable terminal 100.

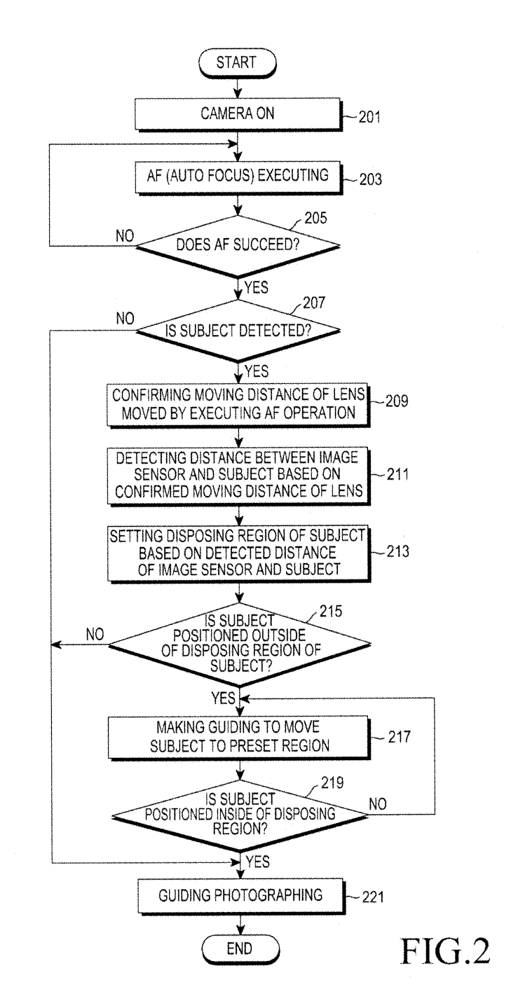

FIG. 2 is a flowchart providing exemplary operation of a photography guide operation according to another exemplary embodiment of the present invention. Referring now to FIG. 2, at step 201, the camera is turned ON through the user's command input, for example, pressing the power button on the portable terminal 100 or the user's voice input through the portable terminal 100.

At step 203, an autofocus (hereinafter, referred to as “AF”) function is executed in a state where the camera lens is directed at a subject. The execution of the AF function may be automatically executed when the camera is turned ON and whatever happens to be within the range of the camera lens upon turning the camera on may comprise the subject. Alternatively, the AF function can be manually executed by inputting a preset AF function execution command, for example, when the user performs a half pushing of the shutter.

At step 205, it is determined whether or not the AF operation is successful. When the AF operation is successful, then step 207 is performed next. However, when the AF operation fails, the AF function in step 203 can be re-executed.

At step 207, according to the result of determination at step 205, it is determined whether a subject is detected or not when the AF operation is successful. At this time, there may be a single subject or two or more subjects, subject being sensed by the image sensor. In addition, in the operation of detecting a subject, a “focused on” object is determined according to the AF operation in an image for prospective recording obtained from the camera in order to detect the subject. From the object focused according to the AF operation, it is then determined whether the object is a person or an animal using, for example, a face recognition technology, and other objects may be determined as an object that is neither a person nor an animal.

According to the determination as to whether or not a subject is detected or not at step 207, when a subject is detected, then step 209 is performed, and when no subject is detected, the inventive operation may be terminated.

When a subject is detected as the result of the determination at step 207, then at step 209, the moving distance of the lens moved while executing the AF operation is confirmed.

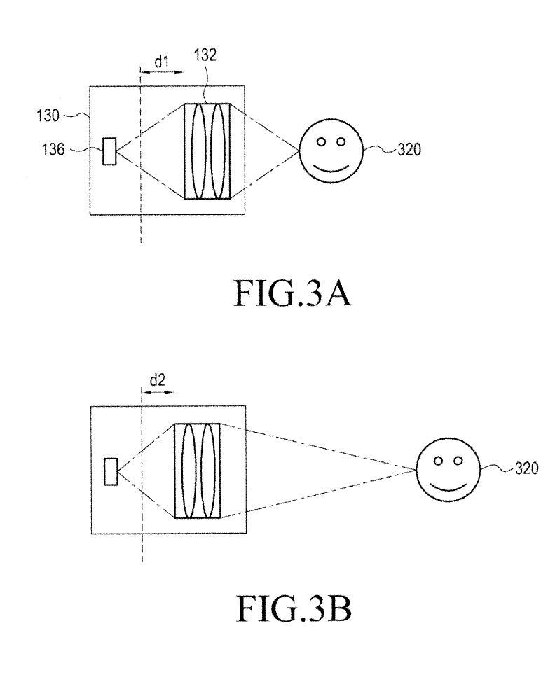

Referring now to FIGS. 3a and 3b, when the subject 320 is positioned relatively closer to the image sensor 136 as illustrated in FIG. 3a than the position of the subject in FIG. 3b, in order to be focused on the subject 320, the lens 132 is moved via the lens driving unit relatively further away from the image sensor 136 as shown by comparing “d1” and “d2” shown respectively in FIGS. 3a and 3b. Moreover, when the subject 320 as shown in FIG. 3b is positioned relatively further away from the image sensor 136 than as shown in FIG. 3a, the lens 132 is moved relatively closer to the image sensor 136 through the lens driving unit 134 in order to be focused on the subject 320. Thus, the distance of the lens unit 132 is positioned relatively further from the image sensor 136 when the subject 320 is relatively closer to the camera module 130.

At step 211, the distance between the image sensor and the subject is detected based on the moving distance of the lens confirmed at step 209.

Thereafter, at step 213, according to a standard preset according to a detected distance between the image sensor and a subject, the disposing region of the detected subject is set.

The detected distance between the image sensor and the subject may be variously classified in relative terms, for example, as a short distance and a long distance, or as a short distance, a middle distance, and a long distance. For example, a middle distance can be a range, in which distances less than the range are classified as short distances and distances greater than the range are classified as long distances. When being classified as the short distance and the long distance, the standard according to the detected distance between the image sensor and subject may be a standard that is set, for example, in such a manner that, in the case of the short distance, for example, the subject is disposed at the center of the screen, and in the case of the long distance, the subject is disposed at the left top end of the screen.

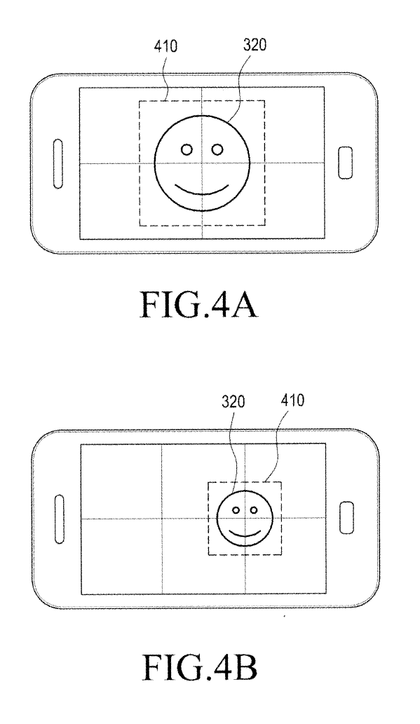

Referring again to FIGS. 3a and 3b, as well as FIGS. 4a and 4b, when the subject is positioned near the image sensor 136 as illustrated in FIG. 3a, the disposing region 410 shown in FIG. 4A may be set in such a manner that, the subject 320 may be positioned at the center of the screen. In addition, when the subject 320 is positioned remotely from the image sensor 136 as illustrated in FIG. 3b, the disposing region 410 shown in FIG. 4B may be set in such a manner that the subject 320 may be positioned at the preset right region of the screen.

In addition, the preset standard according to the detected distance between the image sensor and the subject can be a standard that is set by changing the disposing region of the detected subject from the subject disposing standard region preset according to a previously stored photographic composition. In other words, information colors, contour lines, feature points, etc. classified according to various background types and previously stored in the portable terminal 100, such as a mountain at sunset, a sea with a lighthouse, and a boat floating on the ocean, are analyzed from a current image for prospective recording to grasp (i.e. determine) a background type, and the set subject disposing standard region is confirmed in the determined background type. The disposing region of the subject may be set by changing the confirmed subject disposing standard region to meet a preset standard according to the detected distance between the image sensor and the subject, in other words, depending on whether the detected distance between the image sensor and the subject is determined to be one of a relatively short distance, a middle distance or a long distance. The change of the subject disposing standard region at this time may be variously performed, for example, by moving the disposing standard region or reducing the disposing standard region.

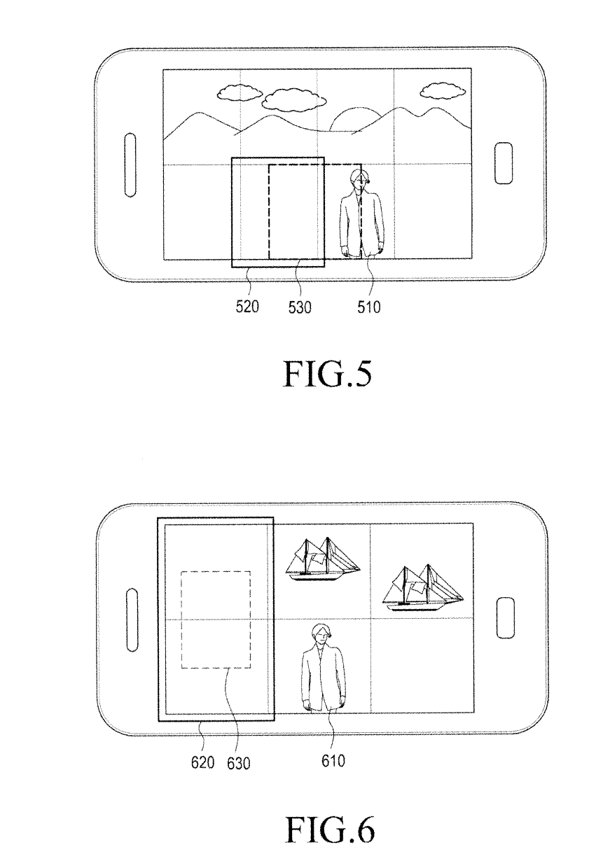

Referring now to FIG. 5, when a subject 510 is photographed with a mountain in the background, the background type can be determined by analyzing the previously stored information colors, contour lines, feature points, etc. classified according to various background types. Then, the subject disposing standard region 520 can be confirmed which is set in the determined background type. The disposing region 530 of the subject can be set by moving the confirmed preset subject disposing standard region 520 according to the detected distance between the image sensor and the subject.

Referring now to FIG. 6, when a subject 610 is photographed with an ocean in the background, the background type may be determined by analyzing the previously stored information colors, contour lines, feature points, etc. classified according to various background types. Then, the subject disposing standard region 620 may be confirmed which is set in the determined background type. The disposing region 630 of the subject may be set in the confirmed subject disposing standard region 620 to meet a preset standard according to the detected distance between the image sensor and the subject. In other words, when the preset standard according to the detected distance between the image sensor and the subject is a standard that is set in such a manner that the disposing region is positioned at the center of the subject disposing standard region, the disposing region of the subject may be set as the center in the confirmed subject disposing standard region.

Additional standards may be preset according to a detected distance between the camera and a subject. For example, when the subject is a person and the detected distance between the camera and the subject is a relatively short distance, the disposing region may be set in such a manner that the face of the person may be positioned at the center of the disposing standard region. When the detected distance is a relatively long distance, the disposing region may be set in such a manner that the waist portion of the person is positioned at the center of the disposing standard region.

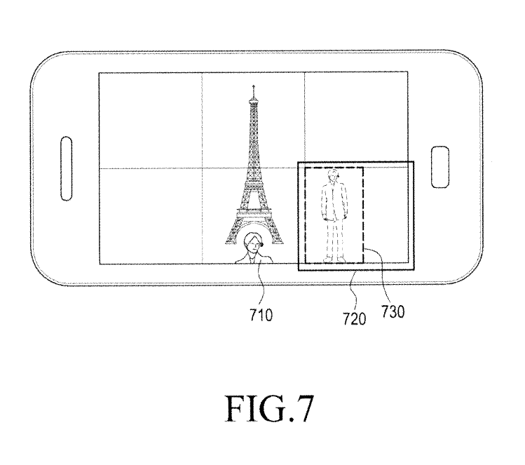

Referring now to FIG. 7, when a subject 710 is photographed with a building in the background, the background type may be determined by analyzing the previously stored information colors, contour lines, feature points, etc. classified according to various background types to confirm the subject disposing standard region 720 set in the determined background type. The disposing region 730 of the subject can be set in the confirmed subject disposing standard region 720 to conform with a preset standard according to the detected distance between the image sensor and the subject. At this time, when the subject is set as a person, the disposing region can be set in such a manner that the waist portion of the person is positioned at the center of the disposing standard region 720 according to the detected distance between the camera and the subject.

Referring back to FIG. 2, at step 215, it is determined whether the subject is positioned outside of the disposing region. When the subject is positioned outside of the disposing region, then step 217 is performed, and when the subject is not positioned outside of the disposing region, then step 221 is performed.

When it is determined at step 215 that the subject is positioned outside of the disposing region, then in step 217, a guide may be displayed to indicate or guide movement of the image of the subject to the disposing region set at step 213. The operation of the guide displayed to move the subject to the set disposing region can be an operation that visually indicates the disposing region translucently by dotted lines or solid lines to overlap with an image on the screen of the display unit 130 of the portable terminal 100 where the current image for prospective recording is displayed. Alternatively, the operation can be an operation that outputs a preset voice or signal sound so that the detected subject may be moved to the disposing region. The voice can be a voice command, that explains the moving direction like, for example, “move right,” so that the subject may be moved to the position of the disposing region according to the position thereof, or by moving the camera, and the camera can then informs the user in some sensory manner that the subject is positioned inside of the disposing region.

At step 219, it is determined whether or not the subject is positioned inside of the disposing region according to the positional movement of the subject. When it is determined at step 219 that the subject is positioned within the disposing region, then step 221 is performed, and when it is determined that the subject is not positioned within the disposing region, the guide operation at step 217 may be performed again to output a guide to move the subject to the set disposing region.

When it is determined at step 219 that the subject is positioned within the disposing region, then at step 221, a photography guide operation is executed. The photography guide operation may be an operation that outputs a preset voice or a signal sound that merely informs the user that the subject is positioned within the disposing region. Alternatively, the portable terminal 100 may perform a vibration operation in order to inform the user that the subject is positioned in the disposing region.

The photography guide method, device, and recording medium using a subject's characteristics according to various aspects of the present invention may be implemented as described above. Although several specific exemplary embodiments have been described, there are other various modifications that may be made that are within the spirit and scope of the claimed invention. For example, the individual operations described herein may be entirely or partially executed in parallel, may be partially omitted, or may include other additional operations.

According to another exemplary embodiment of the present invention, the operation of determining between the distance of the image sensor of the measuring unit 114 of the portable terminal 100 and a subject can be performed by confirming the time required for the light emitted at the time of executing the flash function of the camera to be reflected from the subject and returned to the camera and then determining the distance between the image sensor and the subject based on the confirmed time. It is also within the spirit and scope of the claimed invention that other types of electromagnetic or mechanical waves can be used to determine the distance between the image sensor and the subject.

In addition, when guiding the subject so that the position of the detected subject is arranged within the set disposing region, the operation of visually displaying the position on a screen, the operation of causing a preset voice or signal sound to be output together with the position, and the operation of performing the vibration operation are all performed simultaneously, or only two operations may be performed.

In addition, although the inventive photography guide operations have been described while exemplifying only a single subject in the above-described exemplary embodiments, the inventive photography guide operations can be applied to a plurality of subjects.

In addition, although examples, in which the present invention is executed in a horizontal photographing state, as have been described above, the inventive operations may also be applied to a vertical photographing state. Further, the horizontal photographing and vertical photographing may be guided depending on the distance, background or the like.

Furthermore, although the above-described exemplary embodiments have been described with reference to cases where the present invention is applied to photograph a still picture by way of an example, the present invention may be applied when photographing a moving picture.

The above-described methods according to the present invention can be implemented in hardware, firmware or via the execution of software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitutes hardware in the claimed invention. Under the broadest reasonable interpretation, the appended claims constitute statutory subject matter in compliance with 35 U.S.C. §101 and none of the elements constitute of software per se.

The terms “unit” or “module” as may be used herein is to be understood as constituting hardware such as a circuit, processor or microprocessor configured for a certain desired functionality in accordance with statutory subject matter under 35 U.S.C. §101 and does not constitute software per se.

It will be appreciated that the exemplary embodiments of the present invention may be implemented in a form of hardware, software, a combination of hardware and software. Regardless of being erasable or re-recordable, such an optional software may be stored in a non-volatile storage device such as a ROM, a memory such as an RAM, a memory chip, a memory device, or an integrated circuit, or a storage medium such as a CD, a DVD, a magnetic disc, or a magnetic tape that is optically or electromagnetically recordable and readable by a machine, for example, a computer. It will be appreciated that a memory, which may be incorporated in a portable terminal, may be an example of a machine-readable storage medium which is suitable for storing a program or programs including commands to implement the exemplary embodiments of the present invention.

Accordingly, the present invention can include machine executable code for implementing the devices or methods defined in the accompanying claims, and a machine-readable storage medium in which such machine executable code is stored. In addition, such machine executable code may be electronically transferred using a medium, such as a communication signal that is transmitted through a wired or wireless connection, but in any event, the present invention does not constitute software per se and the machine executable code is loaded into hardware and executed by, for example, a processor, microprocessor, or controller that is configured for operation.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. A photography guide method that uses a subject's characteristic, comprising:
detecting at least one subject in an image for prospective recording obtained from an image sensor;
determining a distance between the image sensor and the subject;
setting a disposing region of the detected subject on a screen where the image for prospective recording is displayed according to the determined distance; and
guiding the detected at least one subject to be positioned in the set disposing region.

2. The method of claim 1, wherein detecting the at least one subject, comprises:
recognizing and detecting an object, which is focused on as an autofocus (AF) function of the image sensor is executed, as the at least one subject.

3. The method of claim 1, wherein determining the distance between the image sensor and the at least one subject comprises:
measuring a moving distance of a lens that moved as an autofocus (AF) function of the image sensor is executed, and
determining the distance between the image sensor and the at least one subject based on at least the measured moving distance of the lens.

4. The method of claim 1, wherein determining the distance between the image sensor and the subject comprises:
confirming a time required for light emitted as a flash function of an electronic device to be reflected from the detected at least one subject and returned to the electronic device, and
determining the distance between the image sensor and the at least one subject based on at least the time required for the light to be reflected from the detected at least one subject and returned to the electronic device.

5. The method of claim 1, wherein setting the disposing region of the detected at least one subject on the screen where the image for prospective recording is displayed according to the determined distance comprises:
changing a subject disposing standard region, which is preset and previously-stored according to a photographic composition, according to the determined distance to set the disposing region of the detected at least one subject.

6. The method according to claim 1, wherein guiding the detected at least one subject to be positioned in the set disposing region comprises:
visually indicating the disposing region on the screen.

7. The method of claim 6, wherein visually indicating the disposing region on the screen is performed when the position of the detected at least one subject is not within the set disposing region.

8. The method of claim 1, wherein guiding the detected subject to be positioned within the set disposing region comprises:
when the position of the detected subject is not within the disposing region, outputting a sound so that the detected at least one subject is guided for movement within the set disposing region.

9. The method of claim 1, wherein guiding the detected at least one subject to be positioned within the set disposing region comprises:
generating a vibration when the detected at least one subject is positioned within the set disposing region.

10. A photography guide device that uses a subject's characteristic, comprising:
an image sensor configured to obtain an image for prospective recording;
a detection unit configured to detect at least one subject from the image for prospective recording obtained through the image sensor;
a measuring unit configured to determine a distance between the image sensor and the subject;
a setting unit configured to set a disposing region of the detected at least one subject on a screen where the image for prospective recording is displayed according to the determined distance; and
a controller configured to control operation of guiding the detected at least one subject to be positioned within the set disposing region.

11. The photography guide device according to claim 10, wherein the detection unit detects an object, which is focused on as an autofocus (AF) function of the image sensor is executed, as the at least one subject.

12. The photography guide device according to claim 10, wherein the measuring unit measures the moving distance of a lens that moved as an autofocus (AF) function of the image sensor is executed, and the measuring unit determines the distance between the image sensor and the at least one subject based on the moving distance of the lens.

13. The photography guide device according to claim 10, wherein the measuring unit measures the time required for light emitted as a flash function during execution of the photography guide device to be reflected from the detected at least one subject and returned to the photography guide device, and determines the distance between the image sensor and the subject based on the time required for the light to be reflected from the detected at least one subject and returned to the electronic device.

14. The photography guide device according to claim 10, wherein the setting unit changes a subject disposing standard region, which is preset and previously-stored according to a photographic composition, according to the determined distance to set the disposing region of the detected at least one subject.

15. The photography guide device according to claim 10, wherein the operation of guiding the detected at least one subject to be positioned in the set disposing region by visually indicating the disposing region on the screen.

16. The photography guide device according to claim 15, wherein, visually indicating the disposing region on the screen is performed when the position of the detected at least one subject is not positioned within the set disposing region.

17. The photography guide device according to claim 10, further comprising a speaker configured to output a sound corresponding to a signal from the camera module,
wherein, when the position of the detected at least one subject is not positioned within the disposing region, the speaker outputs a preset sound so that the detected at least one subject is guided for movement to the set disposing region.

18. The photography guide device of claim 10, further comprising a vibration motor configured to convert an electrical signal into mechanical vibration according to the control of the controller,
wherein, when the position of the detected at least one subject is positioned within the set disposing region, the vibration motor performs a vibration operation.

19. A non-transitory machine-readable storage medium that stores a program comprising machine executable code for executing a photography guide method which uses a subject's characteristics, wherein the program when loaded into a processor for execution of the photograph guide method comprising:
detecting at least one subject in an image for prospective recording obtained from an image sensor;
determining a distance between the image sensor and the at least one subject;
setting a disposing region of the detected at least one subject on a screen where the image for prospective recording is displayed in a position according to the determined distance; and
guiding the detected at least one subject to be positioned in the set disposing region.

20. The storage medium as recited in claim 19, wherein determining the distance between the image sensor and the at least one subject, comprises:
measuring a moving distance of the lens moved as an autofocus (AF) function of the image sensor is executed, and
determining the distance between the image sensor and the subject based on at least the moving distance of the lens.
